(19) United States
(12) Patent Application Publication
(10) Pub. No.: US 2008/0165333 A1
(43) Pub. Date: Jul. 10, 2008

(54) Projection optical apparatus, exposure method and apparatus, photomask, and device and photomask manufacturing method

(75) Inventors: Masato Kumazawa, Sagamihara-shi (JP); Michio Noboru, Kawasaki-shi (JP)

Correspondence Address: OLIFF & BERRIDGE, PLC, P.O. BOX 320850, ALEXANDRIA, VA, 22320-4850, US

(73) Assignee: NIKON CORPORATION, TOKYO (JP)

(21) Appl. No.: 11/987,779

(22) Filed: Dec. 4, 2007

Related U.S. Application Data
(60) Provisional application No. 60/878,452, filed on Jan. 4, 2007.

(51) Int. Cl. G03B 27/42; G03B 27/52

(52) U.S. Cl. 355/53; 355/55

(57) ABSTRACT

When forming a magnified image of a mask pattern on an object with a plurality of projection optical systems, the mask pattern is minimized in size. A projection exposure apparatus relatively moves a mask and a substrate and forms a magnified image of a pattern of the mask. The apparatus includes projection optical systems, each having an enlargement magnification and forming an image of a pattern of the mask on the substrate. A first line segment formed by connecting view points of the projection optical systems on the mask and a second line segment formed by connecting conjugate points of the view points on the substrate form corresponding sides of two similar figures of which magnification ratio is the magnification.

### CROSS-REFERENCE TO RELATED APPLICATIONS

This application is based upon and claims the benefit of priorities from U.S. Provisional Application No. 60/878,452 filed on Jan. 4, 2007, the entire contents of which are incorporated herein by reference.

### BACKGROUND OF THE INVENTION

The present invention relates to a projection optical apparatus for forming a magnified image of a first object such as a mask onto a second object such as a photosensitive substrate, and to an exposure technique and a device manufacturing technique using such a projection optical apparatus.

A projection exposure apparatus, which projects a pattern of a mask (e.g., reticle or photomask) onto a resist-coated substrate (e.g., glass plate or semiconductor wafer) using a projection optical system, is used when manufacturing devices such as semiconductor devices and liquid crystal display devices. A projection exposure apparatus employing a step-and-scan method (stepper) has been widely used in the prior art. The step-and-scan projection exposure apparatus performs batch exposure of mask patterns onto a plurality of shot-regions defined on a plate. A step-and-scan scanning projection exposure apparatus, which uses a plurality of small partial projection optical systems having the same magnification, instead of a single large projection optical system has been proposed recently. In the scanning projection exposure apparatus, the plurality of partial projection optical systems are arranged at predetermined intervals in a number of rows along a scanning direction. The scanning projection exposure apparatus exposes patterns of a mask using the partial projection optical systems onto a substrate while scanning the mask and the substrate.

A proposed step-and-scan projection exposure apparatus uses partial projection optical systems having reduction magnifications to project patterns of a mask onto a substrate as an array having a similar shape with a magnification ratio that is the reduction magnification of the partial optical systems (for example, refer to EP Patent Application Publication No. 825491). In the conventional scanning projection exposure apparatus, the plurality of partial projection optical systems are each provided with a catadioptric system, which forms an intermediate image including a concave mirror (or simply a mirror) and a lens, and a further catadioptric system. Each partial projection optical system forms an erected image of a pattern of the mask on a substrate plate with an equal or reduction magnification.

In recent years, the substrates that are used have become large and may have a size as large as 2×2 meters are increasingly used. When the above-described step-and-scan exposure apparatus, which includes the partial projection optical systems having the equal or reduction magnifications, is used to perform exposure on such a large substrate, the mask is also enlarged. A larger mask results in higher costs due to the need to maintain flatness of the mask substrate and the more complicated manufacturing process that becomes necessary when the mask is enlarged. Further, masks in four to five layers are usually necessary to form, for example, a thin-film transistor portion of a liquid crystal display device. This further increases costs. Accordingly, a scanning projection exposure apparatus that can reduce the size of a mask has been proposed (refer, for example, to U.S. Pat. No. 6,512,573). The scanning projection exposure apparatus uses a multiple lens system that includes a plurality of partial projection optical systems having enlargement magnifications.

In a multiple lens system having an enlargement magnification and using the conventional scanning projection exposure apparatus, the optical axis on a mask and the optical axis on a substrate in each partial projection optical system are located at the same position in a non-scanning direction, which is orthogonal to the scanning direction. Further, the length of a figure in the non-scanning direction at the mask side formed by connecting points on the optical axis in a field of view on a mask with a plurality of partial projection optical systems is equal to the length of a figure in the non-scanning direction at the substrate side formed by connecting points on the substrate that are conjugate to the points on the optical axis.

Therefore, to project an enlarged image of a mask onto a substrate, pattern fields on a mask that correspond to the plurality of partial projection optical systems must be spaced from one another at a predetermined interval in the non-scanning direction. Further, even if an erected image of a mask is formed on the substrate, the width of the mask in the non-scanning direction is substantially the same as what it had been before. Thus, the manufacturing cost of the mask has not been effectively lowered.

### SUMMARY OF THE INVENTION

Accordingly, it is an object of the present invention to provide a projection technique, an exposure technique using the projection technique, and a device manufacturing technique that enables further miniaturization of mask patterns when forming a magnified image of a mask pattern on an object such as a substrate with a plurality of projection optical systems (partial projection systems).

One aspect of the present invention is a projection optical apparatus for forming a magnified image of a first object on a second object. The first object and the second object are relatively moved in a predetermined scanning direction. The projection optical apparatus includes first and second projection optical systems including an enlargement magnification, each of the first and second projection optical systems forming an image of part of the first object on the second object. When two arbitrary view points respectively corresponding to the first and second projection optical systems are defined on the first object, two conjugate points respectively corresponding to the two arbitrary points are defined on the second object, a first line segment is obtained by connecting the two view points, and a second line segment is obtained by connecting the two conjugate points, the first and second projection optical systems are arranged so that the first segment forms one side of a first figure, which is related with part of the first object, and the second line segment forms one side of a second figure, which is related with an image of part of the first object and which is a similar figure of the first figure of which magnification ratio relative to the first figure is the enlargement magnification. A light beam transmission member which transmits a light beam from an arbitrary view point corresponding to at least one of the first and second projection optical systems on the first object to the corresponding conjugate point on the second object by shifting the light beam from the view point in at least a direction orthogonal to the scanning direction.

A second aspect of the present invention is a projection exposure apparatus for exposing a second object with illumination light via a first object. The projection exposure apparatus includes an illumination optical system for illuminating the first object with the illumination light and a projection optical apparatus according to the present invention for forming an image of the first object illuminated by the illumination optical system on the second object. A stage mechanism relatively moves the first object and the second object in the scanning direction using the magnification of the projection optical apparatus as a velocity ratio.

A third aspect of the present invention is a projection optical apparatus for forming a magnified image of a first object on a second object. The first object and the second object are relatively moved in a predetermined scanning direction. The projection exposure apparatus includes first and second projection optical systems including an enlargement magnification, wherein each of the first and second projection optical systems forms an image of part of the first object on the second object. At least one of the first and second projection optical systems includes a light beam transmission member for transmitting a light beam from an arbitrary view point corresponding to the at least one of the first and second projection optical systems on the first object to a corresponding conjugate point on the second object by shifting the light beam from the view point in at least a direction orthogonal to the scanning direction.

A fourth aspect of the present invention is a projection exposure apparatus for exposing a second object with illumination light via a first object. The projection exposure apparatus includes an illumination optical system for illuminating the first object with the illumination light, a projection optical apparatus according to the present invention for forming an image of the first object illuminated by the illumination optical system on the second object, and a stage mechanism for relatively moving the first object and the second object in the scanning direction using the magnification of the projection optical apparatus as a velocity ratio.

A fifth aspect of the present invention is a projection exposure apparatus for forming a magnified image of a first object on a second object while relatively moving the first object and the second object in a predetermined scanning direction. The projection exposure apparatus includes a plurality of projection optical systems including an enlargement magnification, wherein each of the projection optical systems forms an image of part of the first object on the second object. An illumination optical system for forming a plurality of illumination fields on the first object. The plurality of illumination fields are arranged in a direction orthogonal to the scanning direction, with adjacent ones of the illumination fields partially overlapping each other.

A sixth aspect of the present invention is an exposure method for exposing a second object with illumination light via a first object. The exposure method includes illuminating the first object with the illumination light, projecting an image of the illuminated first object onto the second object with a projection optical apparatus according to the present invention, and relatively moving the first object and the second object in the scanning direction using the magnification of the projection optical apparatus as a velocity ratio.

A seventh aspect of the present invention is an exposure method for exposing a second object with illumination light via a first object. The exposure method includes forming a plurality of illumination fields, which includes a first illumination field and a second illumination field differing from the first illumination field, on the first object with the illumination light, forming a magnified image of the first object in accordance with a predetermined magnification in each of a plurality of exposure fields on the second object with light from the plurality of illumination fields, and moving the first object and the second object relative to each other using the predetermined magnification as a velocity ratio. A field swept on the first object by the first illumination field in said moving and a field swept on the first object by the second illumination field in said moving are partially overlapped with each other.

An eighth aspect of the present invention is an exposure method for exposing a second object with illumination light via a first object. The exposure method includes illuminating the first object with the illumination light, projecting an image of the illuminated first object onto the second object with a projection optical apparatus according to the present invention, and relatively moving the first object and the second object in the scanning direction using the magnification of the projection optical apparatus as a velocity ratio.

A ninth aspect of the present invention is a device manufacturing method including exposing a pattern of a mask on a photosensitive substrate using a projection exposure apparatus according to the present invention, developing the photosensitive substrate exposed in said exposing and generating a mask layer shaped in correspondence with the pattern on a surface of the photosensitive substrate, and processing the surface of the photosensitive substrate via the mask.

A tenth aspect of the present invention is a device manufacturing method including exposing a pattern of a mask on a photosensitive substrate using a projection exposure apparatus according to the present invention, developing the photosensitive substrate exposed in said exposing and generating a mask layer shaped in correspondence with the pattern on a surface of the photosensitive substrate, and processing the surface of the photosensitive substrate via the mask.

An eleventh aspect of the present invention is a device manufacturing method including exposing a pattern of a mask on a photosensitive substrate using a projection exposure apparatus according to the present invention, developing the photosensitive substrate exposed in said exposing and generating a mask layer shaped in correspondence with the pattern on a surface of the photosensitive substrate, and processing the surface of the photosensitive substrate via the mask.

In the first projection optical apparatus according to the present invention, a second line segment on a second object is obtained by magnifying a first line segment on a first object with an enlargement magnification. Accordingly, an image formed by magnifying a pattern on the first object with the enlargement magnification directly forms the image on the second object, and the pattern on the first object may be continuously formed in the non-scanning direction, which is orthogonal to the scanning direction. Thus, in the patterns on the first object (mask etc.), there is no need to provide a field that is free from patterns in the non-scanning direction. Further, the size of the patterns may be minimized, and the continuity error of an image projected onto the second object can be reduced.

In the second projection optical apparatus according to the present invention, an equal magnification is used as the magnification ratio so that a first figure and a second figure are similar. View fields (Fields of view) and image fields of the plurality of projection optical systems are continuous in a direction that intersects the scanning direction. Accordingly, the patterns on the first objects can be minimized in size, the patterns on the first object can all be transferred onto the second object through a single scanning exposure, and the throughput of an exposure step can be improved.

In a projection exposure apparatus and exposure method of the present invention, the projection optical apparatus of the present invention is used to perform scanning exposure so as to expose the image of a pattern on the first object that is magnified by an enlargement magnification. This enables the patterns on the first object to be reduced in size and enables miniaturization of a stage for the first object.

In a further projection exposure apparatus and exposure method of the present invention, patterns may be continuously formed in the non-scanning direction on the first object. This enables the patterns on the first object to be all reduced in size, reduces the continuity error of a projected image, and enables miniaturization of a stage for the first object.

### BRIEF DESCRIPTION OF THE DRAWINGS

FIG. 1 is a schematic perspective view showing the structure of a projection exposure apparatus according to a first embodiment;

FIG. 2 is a diagram showing the relationship of illumination fields ILF1 to ILF5 and projection fields EF1 to EF5 of FIG. 1;

FIG. 3 is a diagram showing the positional relationship of a mask MA and a substrate PT of FIG. 1 when scanning exposure is started;

FIG. 4 is a diagram showing the positional relationship of the mask MA and the substrate PT of FIG. 1 during scanning exposure;

FIG. 5 is a diagram showing a first example of projection optical systems PL1 and PL2 of FIG. 1;

FIG. 6 is a diagram showing a second example of the projection optical systems PL1 and PL2 of FIG. 1;

FIG. 7 is a diagram showing the relationship of a view field and an image field in a third example of the projection optical systems PL1 to PL5 of FIG. 1;

FIG. 8 is a perspective view showing a light beam transmission member in the third example of the projection optical systems PL1 to PL5 of FIG. 1;

FIG. 9 is a diagram showing an example in which a magnification center of a second figure on an image field conjugate to a first figure on a view field is located in the first figure;

FIG. 10 is a diagram showing an example in which a magnification center of a second figure on an image field conjugate to a first figure on a view field is located in the first figure;

FIG. 11(A) is a diagram showing an example in which a magnification center of a second figure on an image field conjugate to a first figure on a view field is located outside the first figure, and FIG. 11(B) is a diagram showing the layout of the projection optical systems PL1 and PL2 in this example;

FIG. 12 is a diagram showing a further example in which a magnification center of a second figure on a image field is conjugate to a first figure on a view field;

FIG. 13(A) is a schematic perspective view showing the structure of a projection exposure apparatus according to the second embodiment, and FIG. 13(B) is a diagram showing the layout of projection optical systems PL1 to PL3 of FIG. 13(A);

FIG. 14(A) is a diagram showing the initial layout of the mask MA and substrate PT when scanning exposure is performed for a first time in the second embodiment, FIG. 14(B) is a diagram showing the final layout of the mask MA and substrate PT when scanning exposure is performed for the first time, FIG. 14(C) is a diagram showing the initial layout of the mask MA and substrate PT when scanning exposure is performed for a second time, and FIG. 14(D) is a diagram showing the final layout of the mask MA and substrate PT when scanning exposure is performed for the second time;

FIG. 15 is a perspective view showing a further example of the projection optical system PL2 according to the second embodiment;

FIG. 16 is a diagram showing a further example of the projection optical system PL1 according to the second embodiment;

FIG. 17 is a perspective view showing a further example of the projection optical system PL1 according to the second embodiment;

FIG. 18 is a diagram showing an example in which a first figure, which is formed by connecting points on the mask MA, and a second figure, which is formed by conjugate points on the substrate PT, are in a mirror reflection relationship; and

FIG. 19 is a flowchart showing an example of the procedures for manufacturing a liquid crystal display device using the projection exposure apparatus according to the embodiments.

### DETAILED DESCRIPTION OF THE PREFERRED EMBODIMENTS

### First Embodiment

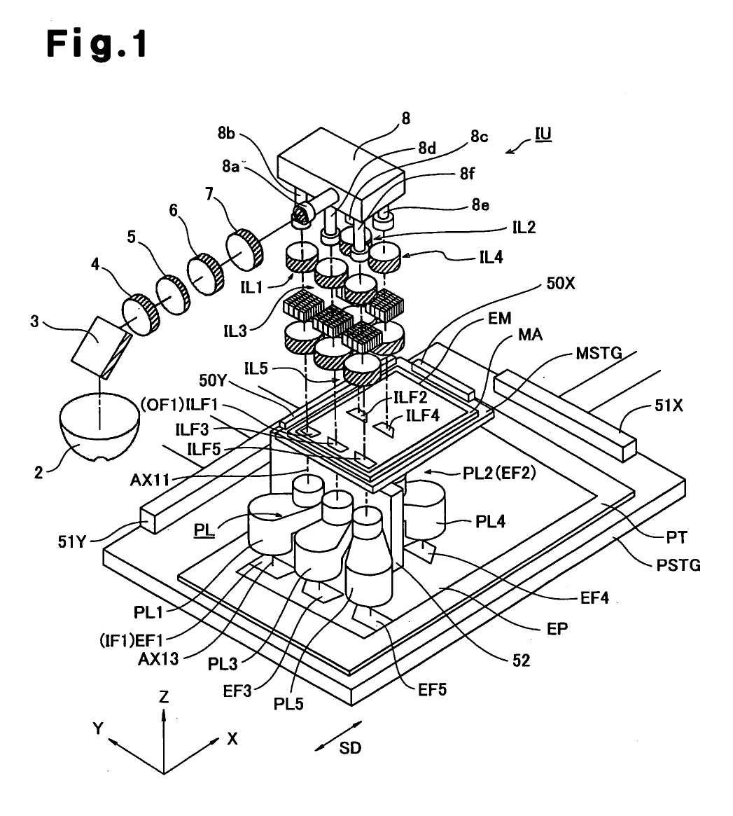

A first embodiment of the present invention will now be described with reference to FIGS. 1 to 12.

FIG. 1 shows a schematic structure of a scanning projection exposure apparatus employing a step-and-scan method according to a first embodiment of the present invention. In FIG. 1, the projection exposure apparatus includes an illumination unit IU, a mask stage MSTG, a projection optical system PL, a substrate stage PSTG, a drive mechanism (not shown), and a control unit (not shown). The illumination unit IU illuminates a pattern of a mask MA (first object) with illumination light emitted from a light source. The mask stage MSTG holds and moves the mask MA. The projection optical system PL projects a magnified image of the pattern of the mask MA onto a substrate (plate) PT (second object). The substrate stage PSTG holds and moves the substrate PT. The drive mechanism includes, for example, a linear motor for driving the mask stage MSTG and the substrate stage PSTG. The control unit centrally controls the operation of the drive mechanism etc. The substrate PT of the present embodiment may be, for example, a rectangular flat glass plate of which side or diagonal line is greater than 500 mm in length. The substrate PT may be coated with photoresist (photosensitive material) used for manufacturing, for example, a liquid crystal display device. A ceramic substrate for manufacturing a thin-film magnetic head or a circular semiconductor wafer for manufacturing a semiconductor device may be used as the substrate PT.

In the illumination unit IU shown in FIG. 1, a light beam emitted from the light source (not shown), which is for example an ultrahigh-pressure mercury lamp, is reflected by an elliptical mirror 2 and a dichroic mirror 3 and enters a collimating lens 4. A reflection coating of the elliptical mirror 2 and a reflection coating of the dichroic mirror 3 selectively reflect light with a certain wavelength range, or specifically reflect light including a g-line (with a wavelength of 436 nm), an h-line (with a wavelength of 405 nm), and an i-line (with a wavelength of 365 nm). As a result, the light including the g, h, and i-lines enters the collimating lens 4. The light source is arranged at a first focal position of the elliptical mirror 2. Thus, the light including the g, h, and i-lines forms a light source image at a second focal position of the elliptical mirror 2. A divergent light beam from the light source image formed at the second focal position of the elliptical mirror 2 is converted into a collimated beam by the collimating lens 4, and the collimated beam passes through a wavelength selective filter 5, which only allows passage of a light beam in a predetermined exposure wavelength range.

The illumination light that has passed through the wavelength selective filter 5 passes through a neutral density filter 6, and then is condensed by a condenser lens 7 onto a light inlet 8a of a light guide fiber unit 8. The light guide fiber unit 8 may be, for example, a random guide fiber unit, which is formed by randomly combining a large number of fibers. The light guide fiber unit 8 has the light inlet 8a and five light outlets (hereafter referred to as light outlets 8b, 8c, 8d, 8e, and 8f). The illumination light that has entered the light guide fiber unit 8 through the light inlet 8a propagates inside the light guide fiber unit 8, and is then emitted separately from the five light outlets 8b to 8f. The light emitted from the five light outlets 8b to 8f enters five partial illumination optical systems (hereafter referred to as partial illumination optical systems IL1, IL2, IL3, IL4, and IL5), each of which partially illuminates the mask MA.

The illumination light emitted from each of the light outlets 8b to 8f of the light guide fiber unit 8 enters the corresponding one of the partial illumination optical systems IL1 to IL5, and is converted into a collimated beam by a collimating lens that is arranged in the vicinity of each of the light outlets 8b to 8f. The collimated light then enters a fly's eye lens array, which is an optical integrator. Illumination light from a large number of secondary light sources that are formed on rear-side focal planes of the fly's array lens array of the partial illumination optical systems IL1 to IL5 illuminates illumination fields ILF1, ILF2, ILF3, ILF4, and ILF5 on the mask MA via condenser lenses in a substantially uniform manner. The illumination unit IU is formed by the optical components described above including the light source to the partial illumination optical systems IL1 to IL5.

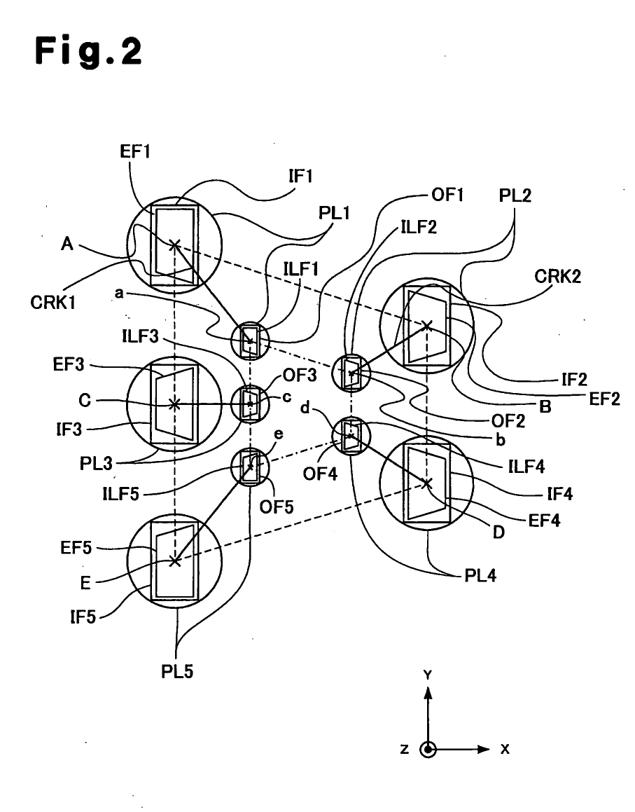

Light from the illumination fields ILF1 to ILF5 formed on the mask MA exposes projection fields EF1, EF2, EF3, EF4, and EF5 (refer to FIG. 2) formed on the substrate PT via first, second, third, fourth, and fifth projection optical systems PL1, PL2, PL3, PL4, and PL5. The first to fifth projection optical systems PL1 to PL5 are mask-side and substrate-side telecentric optical systems. In the present embodiment, the projection optical apparatus PL is formed by the five projection optical systems (partial projection optical systems) PL1 to PL5. The projection optical systems PL1 to PL5 each form a magnified erected image (which is a magnified image with positive horizontal and vertical lateral magnifications) of a pattern included in the corresponding illumination fields ILF1 to ILF5 formed on the mask MA (first surface) on the corresponding projection fields EF1 to EF5 formed on the surface of the substrate PT (second surface) with a enlargement magnification β, which is common to all the projection optical systems PL1 to PL5. The enlargement magnification β may be, for example, 1.5× or greater, and may be, for example, 2.5×. It is preferable that the enlargement magnification β of the partial projection optical systems PL1 to PL5 be 1.5× or greater.

In the present embodiment, the surface on which the mask MA is mounted and the surface on which the substrate PT is mounted are parallel to each other. Hereafter, X-axis is defined as extending along a scanning direction SD of the mask MA and the substrate PT during scanning exposure within a plane parallel to the mounting surface of the substrate PT, Y-axis is defined as extending along a non-scanning direction that is orthogonal to the scanning direction within the plane parallel to the mounting surface of the substrate PT, and Z-axis is defined as extending along a direction perpendicular to the mounting surface of the substrate PT. In this case, the scanning direction of the mask MA and the substrate PT is a direction along the X-axis (X-direction). The non-scanning direction of the mask MA and the substrate PT is a direction along the Y-axis (Y-direction).

In FIG. 1, the mask MA is held through absorption on the mask stage MSTG via a mask holder (not shown). An X-axis movable mirror 50X and a Y-axis movable mirror SOY are fixed on the mask stage MSTG. A first laser interferometer (not shown) is arranged to face the X-axis and Y-axis movable mirrors 50X and 50Y. The first laser interferometer measures the position of the mask stage MSTG and provides the measurement result to a stage drive unit (not shown). The substrate PT is held-trough absorption on the substrate stage PSTG via a substrate holder (not shown). An X-axis movable mirror SIX and a Y-axis movable mirror 51Y are fixed on the substrate stage PSTG. A second laser interferometer (not shown) is arranged to face the X-axis and Y-axis movable mirrors 51X and 51Y. The second laser interferometer measures the position of the substrate stage PSTG and provides the measurement result to the stage drive unit (not shown). The stage drive unit controls the position and the moving velocity of the mask stage MSTG and the substrate stage PSTG based on the measurement values of the first and second laser interferometers. During scanning exposure, the substrate stage PSTG is driven in +X-direction (or −X-direction) at velocity β*VM (where β is the magnification of the projection optical systems PL1 to PL5) in synchronization with the mask stage MSTG that is driven in +X-direction (or −X-direction) at velocity VM.

The partial illumination optical systems IL1, IL3, and IL5 described above are arranged at predetermined intervals in the Y-direction (non-scanning direction) so as to form a first row. In the same manner, the projection optical systems PL1, PL3, and PL5, which correspond to the partial illumination optical systems IL1, IL3, and IL5, are also arranged in a predetermined arrangement in the Y-direction to form a first row. The partial illumination optical systems IL2 and IL4 are arranged in a second row at predetermined intervals in the Y-direction. The partial illumination optical systems IL2 and IL4 in the second row are located at positions shifted in the +X-direction from the first row. The projection optical systems PL2 and PL4, which correspond to the partial illumination optical systems IL2 and IL4, are also arranged at predetermined intervals in the Y-direction in the same manner. The projection optical systems PL2 and PL4 are located at positions shifted in the +X-direction with respect to the first row.

A measurement sensor holding member 52 is arranged between the first-row projection optical systems and the second-row projection optical systems. An off-axis alignment unit and an autofocusing unit are arranged on the measurement sensor holding member 52. The off-axis alignment unit aligns the substrate PT. The autofocusing unit measures the Z-direction positions of the mask MA and the substrate PT (focus positions). In the same manner, an alignment unit (not shown) for aligning the mask MA is also arranged on the mask MA. These alignment units are used to align the mask MA and the substrate PT to perform exposure in an overlapped manner on the substrate PT. Based on the measurement results of the autofocusing unit, a Z-drive mechanism (not shown) is used to adjust, for example, the Z-direction position of the mask stage MSTG, to focus the imaging surfaces of the projection optical systems PL1 to PL5 on the surface of the substrate PT.

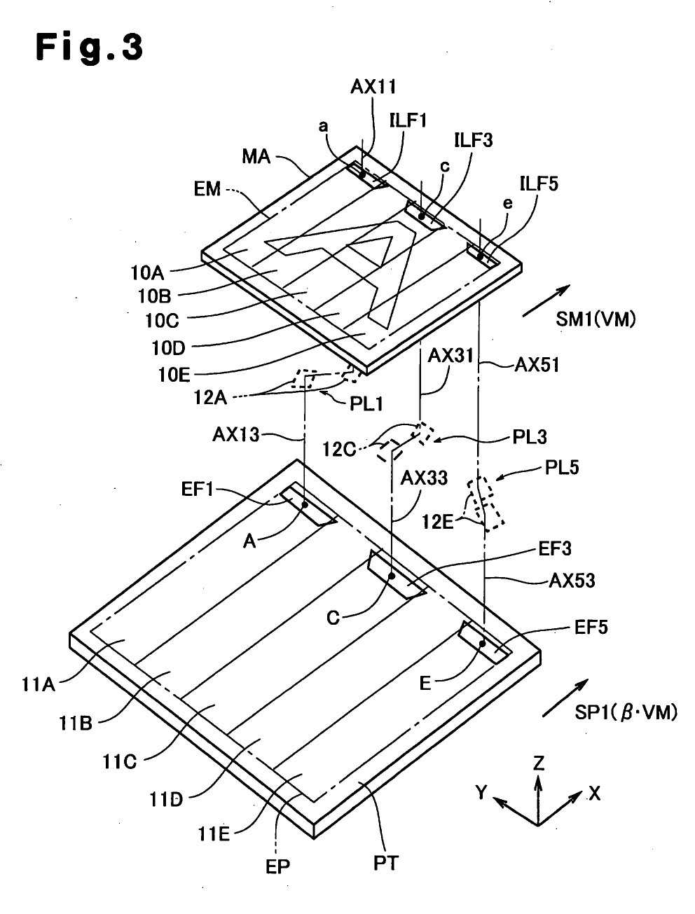

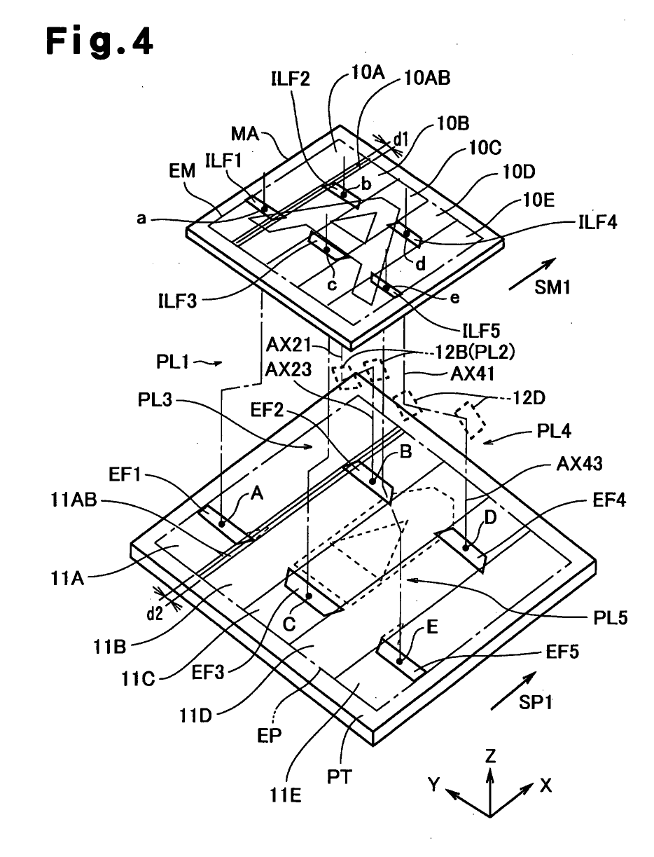

The structure of the projection optical systems PL1 to PL5 according to the present embodiment will now be described in detail. FIG. 2 is a plan view showing the relationship between the illumination fields ILF1 to ILF5 and the projection fields EF1 to EF5 that are conjugate to each other with respect to the projection optical systems PL1 to PL5 shown in FIG. 1. FIGS. 3 and 4 show the positional relationship between the mask MA and the substrate PT during scanning exposure.

In FIG. 2, the illumination fields ILF1 to ILF5 on the mask MA are set in view fields OF1, OF2, OF3, OF4, and OF5 of the projection optical systems PL1 to PL5. Points that are included in the view fields and are on optical axes AX11, AX21, AX31, AX41, and AX51 (refer to FIGS. 3 and 4) are referred to as points a, b, c, d, and e, respectively. Further, the projection fields EF1 to EF5 on the substrate PT are set in image-fields IF1, IF2, IF3, IF4, and IF5 of the projection optical systems PL1 to PL5. Points that are included in the image fields and are on optical axes AX13, AX23, AX33, AX43, and AX53 (refer to FIGS. 3 and 4) are referred to as points A, B, C, D, and E, respectively. In the present embodiment, the points a to e on the mask MA are also the points included in the illumination fields ILF1 to ILF5. The points A to E on the substrate PT, which are conjugate to the points a to e with respect to the projection optical systems PL1 to PL5, are also the points included in the projection fields EF1 to EF5.

The points a, c, and e (points on the optical axes) included in the illumination fields ILF1, ILF3, and ILF5 of the first, third, and fifth projection optical systems PL1, PL3, and PL5 in the first row are arranged on a straight line that is parallel to the non-scanning direction (Y-direction). A straight line linking the points b and d (points on the optical axes) included in the illumination fields ILF2 and ILF4 of the second and fourth projection optical systems PL2 and PL4 in the second row is parallel to a straight line on which the points a, c, and e are arranged and distant from the straight line on which the points a, c, and e are arranged by a predetermined distance. The illumination fields ILF1, ILF3, and ILF5 in the first row each have substantially the same trapezoidal shape whose two sides in Y-direction are the oblique sides of the trapezoid (although the illumination fields ILF1 and ILF5 arranged at the two ends each have an outer side parallel to the X-axis). The illumination fields ILF2 and ILF4 in the second row each have a trapezoidal shape that is obtained by a 180-degree rotation of the illumination field ILF3. The projection optical systems PL1 to PL5 of the present embodiment each form an erected image with the enlargement magnification β. Thus, the projection fields EF1 to EF5 have trapezoidal shapes obtained by magnifying the corresponding illumination fields ILF1 to ILF5 with the enlargement magnification β.

A first figure abdec having a trapezoidal shape is formed by linking the five points a to e on the mask MA. A second figure ABDEC having a trapezoidal shape is formed by linking five points on the substrate PT that are conjugate to the points a to e. In the present embodiment, the second figure ABDEC is a similar figure of an erected image of the first figure abdec. The magnification of the second figure ABDEC with respect to the first figure abdec is equal to the enlargement magnification β of the projection optical systems PL1 to PL5. Further, in the present embodiment, the optical axes AX11 to AX15 of the projection optical systems PL1 to PL5 at the side of the mask MA are parallel to Z-axis. The optical axes AX13 to AX53 on the substrate PT are perpendicular to Z-axis. Thus, when the second figure ABDEC is similar to the first figure abdec using the enlargement magnification β with respect to the first figure abdec, at least four of the five projection optical systems PL1 to PL5 need to include beam transmission members for shifting light beams coming from points (viewing point) included in the corresponding illumination fields on the mask MA at least in the Y-direction (non-scanning direction) by a predetermined shift amount (transfer amount) and transferring the light beams to points included in the corresponding projection fields on the substrate PT. In the present embodiment, point C on the substrate PT is shifted in the −X-direction from point c on the mask MA. Thus, the corresponding third projection optical system PL3 includes a beam transmission member 12C for transferring a light beam from a point included in the illumination field ILF3 in the −X-direction (refer to FIG. 3). The other points A, B, D, and E on the substrate PT are shifted in the X-direction and Y-direction outward from the points a, b, d, and e on the mask MA. Thus, the corresponding projection optical systems PL1, PL2, PL4, and PL5 include beam transmission members 12A, 12B, 12D, and 12E for transferring light beams from points included in the corresponding illumination fields in the X-direction and Y-direction (refer to FIGS. 3 and 4). Further, the beam transmission members 12A to 12E may also be regarded as optical systems that first deflect the optical axes AX11 to AX51 that are perpendicular to the mask MA and shift the optical axes AX11 to AX51 in X-direction and Y-direction by the predetermined shift amount and then again deflect the optical axes AX11 to AX51 to generate the optical axes AX13 to AX53 that are again perpendicular to the substrate PT. When main light beams from the projection optical systems PL1 to PL5 do not have to be perpendicular to the substrate PT or when the projection optical systems PL1 to PL5 do not have to be substrate-side telecentric optical systems, the projection optical systems PL1 to PL5 may be, for example, perspective correction optical systems. This eliminates the need for the beam transmission members to form the second figure ABDEC to be similar to the first figure abdec. In this case, the perspective correction optical systems also function as the beam transmission members.

In FIG. 2, when the second figure ABDEC is similar to the first figure abdec at the enlargement magnifications with respect to the first figure abdec as in the present embodiment, a first figure that is formed by linking any points in the view fields OF1 to OF5 of the projection optical systems PL1 to PL5 and a second figure that is formed by linking points in the image fields IF1 to IF5, which are conjugate to the points in the view fields OF1 to OF5, are similar figures magnified with the enlargement magnification β.

In FIG. 2, the two projection optical systems PL1 and PL2 will now be focused as one example. A first line segment ab, which links the points a and b included in the illumination fields ILF1 and ILF2 of the projection optical systems PL1 and PL2, and a second line segment AB, which links the points A and B included in the projection fields EF1 and EF2 that are conjugate to the points a and b, may be referred to as similar figures whose magnification is the enlargement magnification β. The first line segment ab and the second line segment AB may also be referred to as line segments that form the corresponding sides of the first figure abdec and the second figure ABDEC, which are similar figures whose magnification is the enlargement magnification β. In this case as well, at least one of the projection optical systems PL1 and PL2 needs to include a beam transmission member for shifting and directing the light beams coming from points included in the illumination fields on the mask MA to the corresponding projection fields on the substrate PT.

In FIG. 2, the illumination fields ILF1, ILF3, and ILF5 in the first row are arranged at regular intervals in the Y-direction. In this state, the illumination fields ILF2 and ILF4 in the second row are moved in the X-direction by the predetermined. As a result, interval oblique side portions of the illumination fields ILF1, ILF3, and ILF5 and oblique side portions of the illumination fields ILF2 and ILF4 overlap each other. Further, the five illumination fields ILF1 to ILF5 (and consequently the view fields OF1 to OF5) are arranged continuous to one another in the Y-direction. Thus, the projection fields EF1 to EF5 (and consequently the image fields IF1 to IF5), which are conjugate to the illumination fields-ILF1 to ILF5, are arranged continuous to each other in Y-direction when moved relative to one another in X-direction. In other words, the view fields OF1 to OF5 and the image fields IF1 to IF5 are arranged continuous to one another in a direction intersecting with the scanning direction (direction orthogonal to the scanning direction in this example).

As shown in FIG. 3, a pattern field EM formed on the mask MA may include five partial fields 10A, 10B, 10C, 10D, and 10E, which correspond to the five illumination fields ILF1 to ILF5 in FIG. 2. The five partial fields 10A to 10E each have the same width in the Y-direction. The partial fields 10A to 10E are actually continuous to one another in the Y-direction. During manufacture of the mask MA, a circuit pattern (of letter A) is formed continuously in the entire pattern field EM. This downsizes the pattern field EM of the mask MA. Further, the manufacturing cost of the mask MA is reduced and the mask stage MSTG shown in FIG. 1 is downsized. This reduces the manufacturing cost of the projection exposure apparatus. A pattern transfer field EP on the substrate PT may also include five partial fields 11A, 11B, 11C, 11D, and 11E, each having the same width in the Y-direction. The partial fields 11A to 11E are also actually continuous to each other.

In this case, the partial fields 10A, 10C, and 10E, which are alternate partial fields on the mask MA, are illuminated with the first-row illumination fields ILF1, ILF3, and ILF5. The partial fields 10B and 10D, which are between the partial fields 10A, 10C, and 10E, are illuminated with the second-row illumination fields ILF2 and ILF4 as shown in FIG. 4. Boundary portions of the illumination fields ILF1 to ILF5 are overlapped portions of adjacent illumination fields. Each boundary portion has an overlapping width d1 in the Y-direction. The boundary portion of the illumination fields ILF1 and ILF2 is shown as one example. The boundary portions of the partial fields 10A to 10E are illuminated with two illumination fields in an overlapped manner. As one example, the boundary-portion 10AB of the partial fields 10A and 10B, which has the width d1, is illuminated with the illumination fields ILF1 and ILF2 in an overlapped manner. As a result, the partial fields 11A, 11C, and 11E, which are alternate partial fields on the substrate PT, are exposed with the first-row projection fields EF1, EF3, and EF5. The partial fields 11B and 11D, which are between the partial fields 11A, 11C, and 11E, are exposed with the second-row projection fields EF2 and EF4. Further, boundary portions of the projection fields EF1 to EF5 are overlapped portions of adjacent projection fields. Each boundary portion has a width d2 (obtained by magnifying the width d1 with the enlargement magnification) in the Y-direction. The boundary portion of the projection fields EF1 and EF2 is shown in the figure as one example. The boundary portions of the partial fields 11A to 11E are also illuminated with two projection fields in an overlapped manner. As one example, the boundary portion 11AB of the partial fields 11A and 11B, which has the width d2, is illuminated with the projection fields EF1 and EF2 in an overlapped manner. This method eliminates errors in the continuity in the boundary portions of the partial fields 11A to 11E on the substrate PT although the five projection fields EF1 to EF5 of the substrate PT are exposed separately.

A continuous circuit pattern is formed in the entire pattern field EM of the mask MA. This reduces writing errors of the circuit pattern on the mask MA and consequently reduces errors in the continuity of images projected onto the second object. In contrast, when the circuit pattern formed in a plurality of discrete fields formed on the mask MA is projected onto the second object, writing errors may occur in the circuit pattern formed in the plurality of discrete fields of the mask MA.

When the pattern of the mask MA is transferred onto the substrate PT, the mask MA is moved so as to illuminate the front side of the illumination fields ILF1 to ILF5 (e.g., −X-direction) in FIG. 1, and the substrate PT is moved so as to transfer patterns to the front side of the projection fields EF1 to EF5. Afterwards, the mask stage MSTG and the substrate stage PSTG are driven in synchronization in the +X-direction using the projection magnification β as a velocity ratio. As a result, the partial fields 10A, 10C, and 10E of the mask MA first start being illuminated at the first-row illumination fields ILF1, ILF3, and ILF5. Then, the patterns in the illumination fields ILF1, ILF3, and ILF5 are transferred to the projection fields EF1, EF3, and EF5 on the partial fields 11A, 11C, and 11E formed on the substrate PT via the projection optical systems PL1, PL3, and PL5. Afterwards, the mask MA and the substrate PT are scanned in synchronization with each other in +X-direction as indicated by arrows SM1 and SP1. As a result, the partial fields 10B and 10D of the mask MA start being illuminated with the second-row illumination fields ILF2 and ILF4 as shown in FIG. 4. The patterns included in the illumination fields ILF2 and ILF4 are transferred to the projection fields EF2 and EF4 formed on the partial fields 11B and 11D on the substrate PT via the projection optical systems PL2 and PL4. When the pattern field EM of the mask MA is scanned with the second-row illumination fields ILF2 and ILF4 and the pattern transfer field EP on the substrate PT is scanned with the second-row projection fields EF2 and EF4, a magnified erected image of the entire pattern in the pattern field EM on the mask MA, which has been magnified with the projection magnification β, is transferred to the pattern transfer field EP formed on the substrate PT.

As described above, the boundary portions of the partial fields 10A to 10E on the mask MA, which each have the width d1 in Y-direction, are illuminated in an overlapped manner in adjacent illumination fields ILF1 to ILF5. As a result, the boundary portions of the partial fields 11A to 11E on the substrate PT, which each have the width d2 in Y-direction, are exposed twice with the adjacent projection fields EF1 to EF5. This eliminates errors in the continuity of images in the boundary portions. Further, the pattern of the mask MA is formed continuously in the present embodiment. Thus, the mask MA itself has no discontinuous portions. This also reduces errors in the continuity of images on the substrate PT. After the scanning exposure is performed, the substrate PT on the substrate stage PSTG in FIG. 1 is replaced with another substrate and then the mask MA and the substrate are driven in synchronization with each other in the −X-direction. This transfers a magnified image of the pattern of the mask MA onto the next substrate.

In the present embodiment described above, the first figure abdec, which is formed by linking the points a to e included in the illumination fields ILF1 to ILF5 of the projection optical systems PL1 to PL5 on the mask MA, and the second figure ABDEC, which is formed by linking the points A to E included in the projection fields EF1 to EF5 on the substrate PT that are conjugate to the points a to e, are similar figures in which the second figure ABDEC is obtained from the first figure abdec using the enlargement magnification β as the magnification ratio. The illumination fields ILF1 to ILF5 and the projection fields EF1 to EF5 become continuous to one another in the Y-direction (non-scanning direction) when moved relative to each other in the X-direction. As a result, the mask MA and the substrate PT are scanned once in synchronization using the enlargement magnification β as a velocity ratio while the magnified image of the pattern of the mask MA is projected onto the substrate PT via the projection optical systems PL1 to PL5 (projection optical apparatus PL). This enables the pattern of the mask MA to be transferred onto the substrate PT with high precision with a high throughput and extremely small continuity errors.

In the present embodiment, the illumination fields ILF1 to ILF5 of the projection optical systems PL1 to PL5 on the mask MA are elongated in the Y-direction (direction orthogonal to the scanning direction) as shown in FIG. 2. The projection fields EF1 to EF5 (image fields of the projection optical systems PL1 to PL5) on the substrate PT, which are conjugate to the illumination fields ILF1 to ILF5, are also elongated in Y-direction (direction orthogonal to the scanning direction). Thus, the projection fields EF1 to EF5 occupy only a smaller width in the scanning direction. This minimizes the idling distance of the substrate PT (or the mask MA) and improves the throughput.

Various examples of the projection optical systems PL1 to PL5 according to the present embodiment will now be described. As described above, the projection optical systems PL1 to PL5 are required to satisfy the two conditions described below.

1) The projection optical systems PL1 to PL5 each form an erected image on the substrate with the common enlargement magnification β.

2) At least four of the projection optical systems PL1 to PL5 each include a beam transmission member for shifting a light beam from the corresponding illumination field on the mask MA at least in the Y-direction (or X-direction and −Y-direction) and directing the light beam to the corresponding projection field on the substrate PT so that the second figure ABDEC on the substrate PT is similar to the first figure abdec on the mask MA in FIG. 2 and magnified using enlargement magnification β as the magnification ratio.

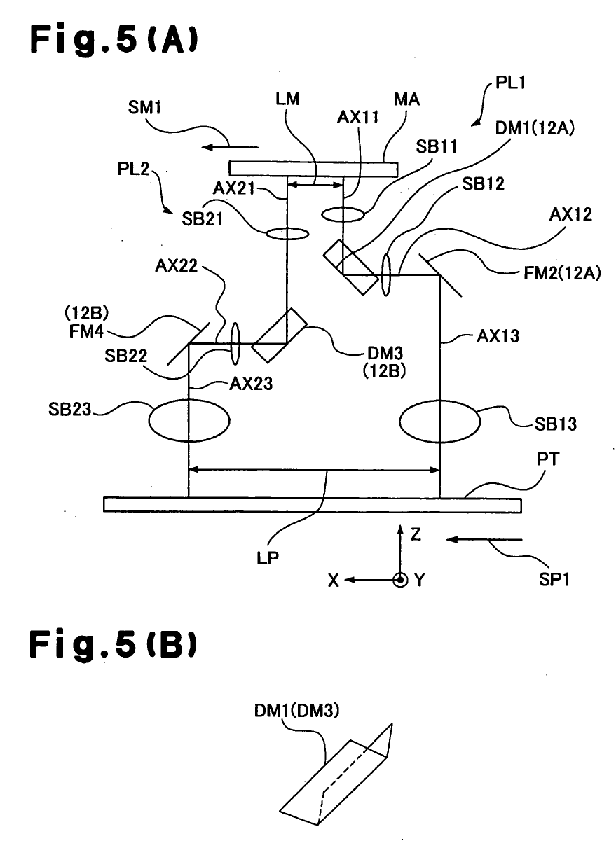

FIG. 5(A) shows projection optical systems PL1 and PL2 according to a first example. The projection optical system PL1 (PL2) includes three partial optical systems SB11, SB12, and SB13 (SB21, SB22, and SB23), a Dach (roof) mirror DM1 (DM3), and a mirror FM2 (FM4). The Dach mirror DM1 (DM3) deflects an optical axis AX11 (AX21), which is at the side of the mask MA and parallel to the Z-axis, to generate an optical axis AX12 (AX22) within the XY plane and invert a light beam. The mirror FM2 (FM4) again deflects the optical axis AX12 (AX22) to generate an optical axis AX13 (AX23), which is at the side of the substrate PT and parallel to Z-axis. In this case, the Dach mirror DM1 (DM3) has two vertical reflection surfaces, which invert a light beam entering the Dach mirror DM1 (DM3) as shown in FIG. 5(B).

In FIG. 5(A), the three partial optical systems SB11, SB12, and SB13 of the projection optical system PL1 are imaging optical systems (may be refractive systems or catadioptric systems) that together form a magnified inverted image of a pattern of a mask MA, magnified at a enlargement magnification β, onto a substrate PT. The Dach mirror DM1 and the mirror FM2 convert the inverted image to an erected image. In this case, the Dach mirror DM1 functions not only as a beam transmission member 12A but also as an optical component for forming the erected image. The same structure applies to the other projection optical systems PL2 to PL5. The Dach mirror DM1 (DM3), which functions as the beam transmission member 12A (12B), and the mirror FM2 (FM4) shift a light beam from the mask MA. The distance (or length of a line segment) between points on the optical axes of the projection optical systems PL1 and PL2 on the mask MA is referred to as a distance LM. The distance (or length of a line segment) between points on the substrate PT conjugate to the points on the mask MA is referred to as a distance LP. The magnification of the distance LP with respect to the distance LM is equal to the enlargement magnification β.

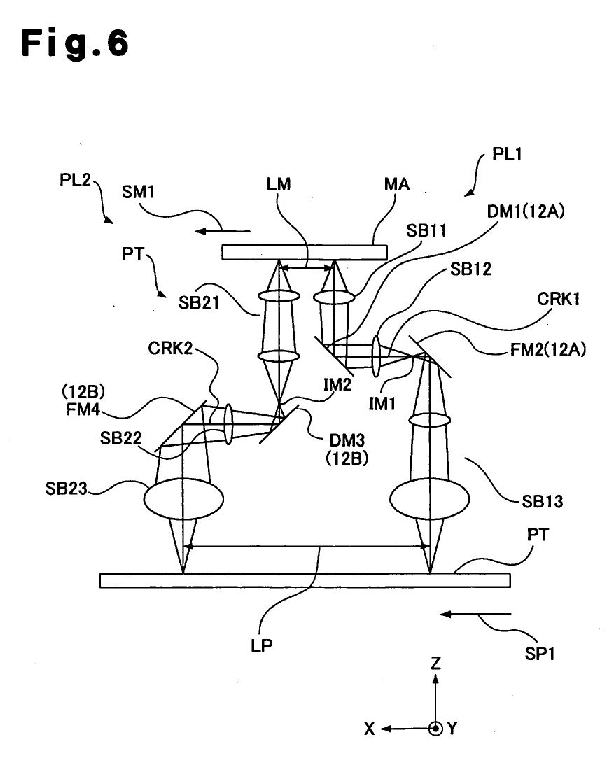

FIG. 6 shows projection optical systems PL1 and PL2 according to a second example. In FIG. 6, the projection optical system PL1 (PL2) includes a first imaging optical system (SB21), a second imaging optical system SB13 (a second imaging optical system including a front group SB22 and a rear group SB23), a mirror DM1 (DM3), and a mirror FM2 (FM4). The first imaging optical system includes a front group SB11 and a rear group SB12 for forming an inverted intermediate image IM1 (IM2) of a pattern of a mask MA. The second imaging optical system SB13 forms an inverted image of the intermediate image onto a substrate PT. The mirror DM1 (DM3) deflects an optical axis that is at the side of the mask MA to generate an optical axis CRK1 (CRK2) within the XY plane. The mirror FM2 (FM4) deflects the optical axis CRK1 (CRK2) to generate an optical axis that is at the side of the substrate PT. In this case, the first and second imaging optical systems of the projection optical system PL1 together form a magnified erected image of the pattern of the mask MA, magnified at a enlargement magnification β, on the substrate PT. The two mirrors DM1 and FM2 function as a beam transmission member 12A for shifting a light beam from the mask MA and directing the light beam to the side of the substrate PT. Such a structure is employed in the same manner in other projection optical systems PL2 to PL5.

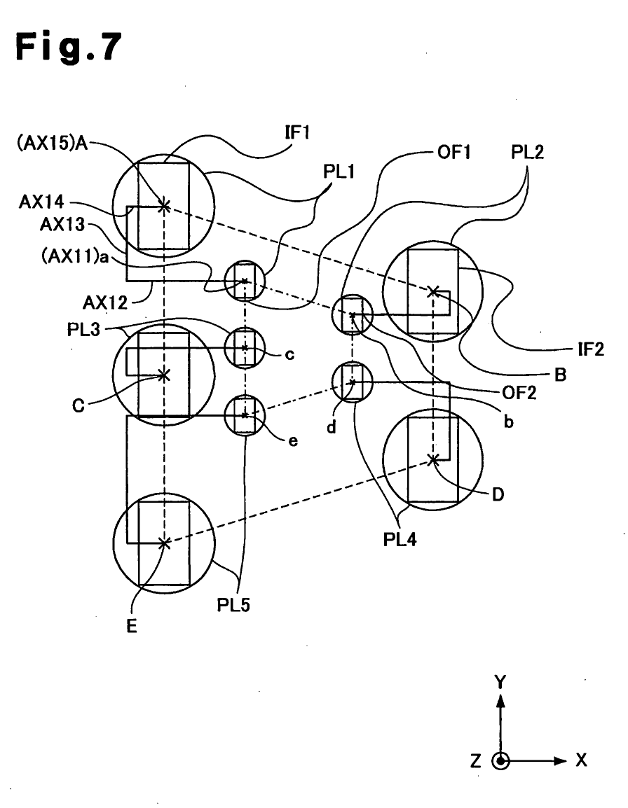

FIG. 7 shows projection optical systems PL1 to PL5 according to a third example. In FIG. 7, an optical axis of the projection optical system PL1 is deflected to generate an optical axis AX11 that is parallel to the Z-axis, an optical axis AX12 that is parallel to the X-axis, an optical axis AX13 that is parallel to the Y-axis, an optical axis AX14 that is parallel to the X-axis, and an optical axis AX15 that is at the side of the substrate PT and parallel to the Z-axis from the side closer to a mask MA. The optical axis of the projection optical system PL1 is deflected in this manner to form an erected image of a pattern of the mask MA on the substrate PT based on the same principle as a Porro-prism erecting system. Further, the second figure ABDEC is similar the first figure abdec and obtained using the enlargement magnification β as a magnification ratio. As a result, the imaging optical systems included in the projection optical system PL1 may be a normal optical system that forms an inverted image of the pattern of the mask MA only once on the substrate PT or an optical system that forms an even number of intermediate images. Such a structure is employed in the same manner in other projection optical systems PL2 to PL5.

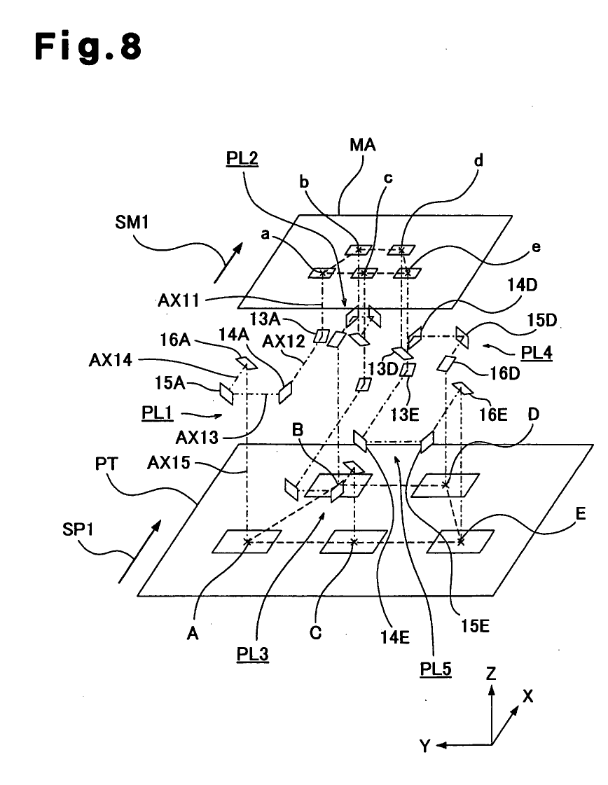

FIG. 8 shows the layout of mirrors included in the projection optical systems PL1 to PL5 for deflecting (folding) the light beam or the optical axis in the manner shown in FIG. 7. In FIG. 8, the projection optical system PL1 includes four mirrors, or specifically first, second, third, and fourth mirrors (deflection members (folding members)) 13A, 14A, 15A, and 16A, which are arranged in order from the side closer to the mask MA. The first to fourth mirrors 13A to 16A deflect the optical path of the light beam from the mask MA (or the corresponding optical axis). A plane including normal vectors of the reflection surfaces of the second and third mirrors 14A and 15A on the optical axis is parallel to the pattern surface (XY plane) of the mask MA. The light beam reflected on the second mirror 14A and entering the third mirror 15A is directed in the Y-direction that intersects with the scanning direction (X-direction) of the mask MA. The four mirrors 13A to 16A enable an erected image of the pattern of the mask MA to be formed on the substrate PT. The four mirrors 13A to 16A also function as the beam transmission member for transferring the light beam from the mask MA to the side of the substrate PT. Such a structure is employed in the same manner in the other projection optical systems PL2 to PL5. For example, the projection optical system PL4 (PL5) includes mirrors 13D to 16D (14E to 16E).

The projection optical system PL1 may include mirrors other than the four mirrors 13A to 16A.

The second figure ABDEC in FIG. 2 is an erect figure that is similar to the first figure abdec and obtained using the enlargement magnification β as a magnification ratio. The magnification center of these figures (the center of similitude) may be located at any position as apparent from the modifications described below. The figure abdec or the like, which is formed by linking the points in the view fields of the projection optical systems PL1 to PL5, may have any shape.

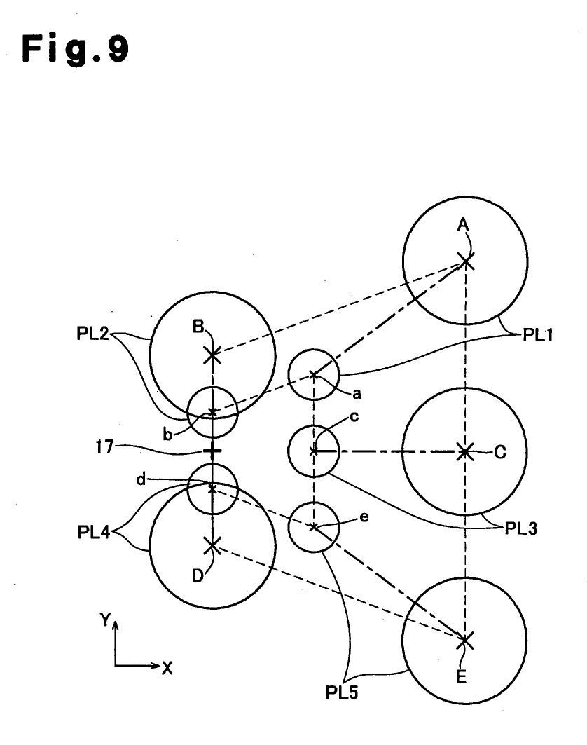

FIG. 9 shows a modification in which first and second figures are formed when a magnification center 17 of the figures is located in the middle of a line segment linking the points b and d included in the view fields of the projection optical systems PL2 and PL3.

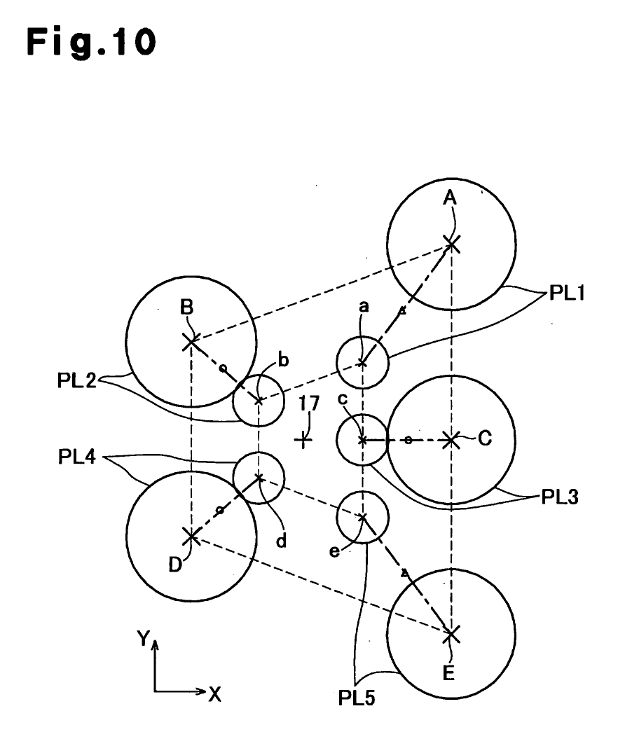

FIG. 10 shows first and second figures formed when a magnification center 17 of the figures is located in the vicinity of the center of the first figure abdec, which is formed by linking the points a to e included in the view fields of the projection optical systems PL1 to PL5, and the beam transmission members of the first to fifth projection optical systems PL1 and PL5 each transfer the light beam by the same shift amount (transfer the optical axis by the same shift amount) and the beam transmission members of the second to fourth projection optical systems PL2 to PL4 each transfer the light beam by the same shift amount. In this case, the projection optical systems PL1 and PL5 may have the same structure, and the projection optical systems PL2 to PL4 may have the same structure.

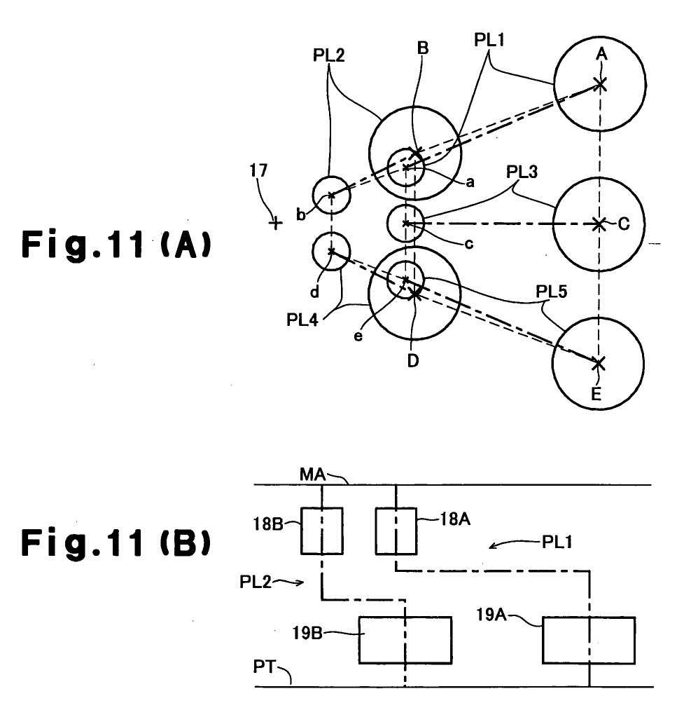

FIG. 11(A) shows a modification in which first and second figures are formed when a magnification center 17 of the figures is located outside the first figure abdec, which is formed by linking the points a to b included in the view fields of the projection optical systems PL1 to PL5. In this case, the first projection optical system PL1, which includes the optical systems 18A and 19A, shifts the light beam by a greater shift amount than the second projection optical system PL2, which includes the optical systems 18B and 19B, as shown in FIG. 11(B).

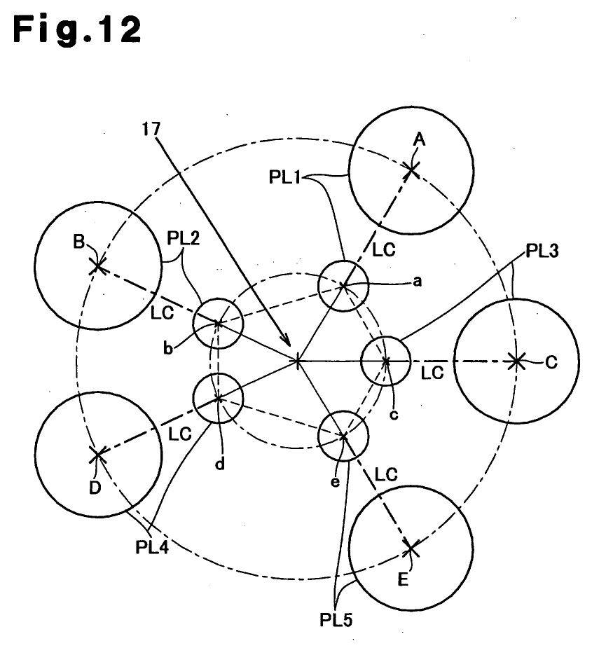

FIG. 12 shows a modification in which first and second figures are formed when a magnification center 17 of the figures is located in the vicinity of the center of the first figure abdec, which is formed by linking the points a to e included in the view fields of the projection optical systems PL1 to PL5, and the beam transmission members of the projection optical systems PL1 to PL5 each transfer the light beam by the same shift amount LC (transfer the optical axis by the same shift amount). In this case, the projection optical systems PL1 to PL5 may have the same structure. This reduces the manufacturing cost of the projection optical systems.

In the above embodiment, the second figure, which is formed by linking the points A to E included in the view fields that are conjugate to the points a to e included in the view fields of the projection optical systems PL1 to PL5, is an erected image of the first figure, which is formed by linking the points a to e. Alternatively, the second figure may be an inverted image of the first figure or an erected image of the first figure only in the X-direction or only in the Y-direction.

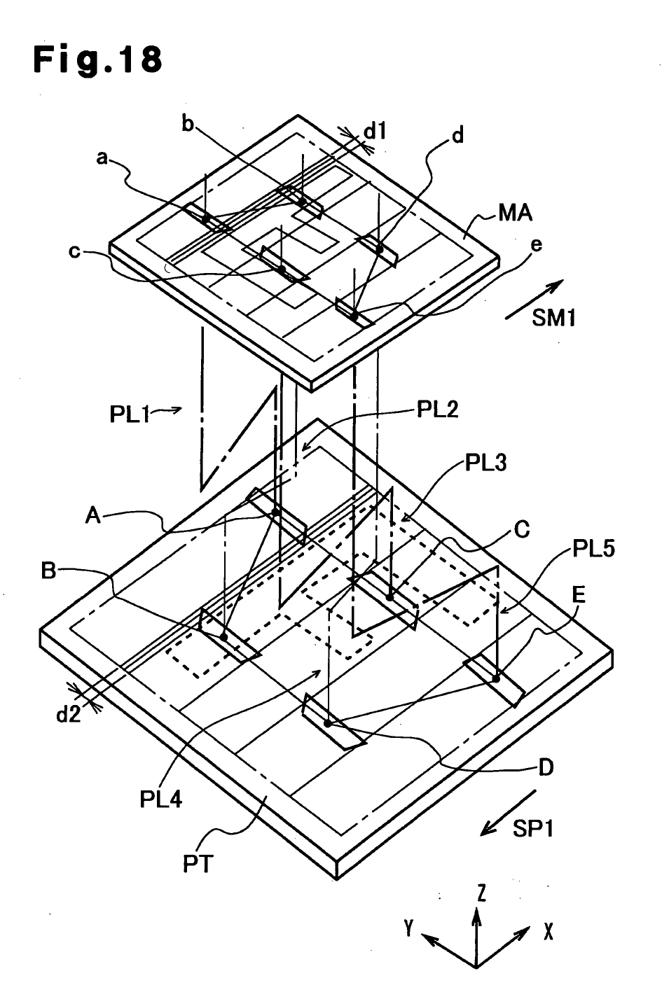

FIG. 18 shown a modification in which a first figure abdec is formed by linking points a to e that are included in the illumination fields (view fields) of the projection optical systems PL1 to PL5 on the mask MA and are on the optical axes of the projection optical systems PL1 to PL5. The projection optical systems PL1 to PL5 have the enlargement magnification β. A second figure ABDEC is formed by linking points A to E that are included in the projection fields (image fields) on the substrate PT and are on the optical axes of the projection optical systems PL1 to PL5. The points A to E are conjugate to the points a to e with respect to the projection optical systems PL1 to PL5. The second figure ABDEC is a magnified image of a figure that is line-symmetric to the first figure abdec with respect to Y-axis and magnified with the enlargement magnification β. In this case, the second figure ABDEC is an inverted image of the first figure abdec in the scanning direction (X-direction) and is an erected image of the first figure abdec in the non-scanning direction (Y-direction). Thus, each of the projection optical systems PL1 to PL5 is required to form an image of the pattern of the mask MA that is an inverted image in the scanning direction and an erected image in the non-scanning direction onto the substrate PT. In this example, an original pattern (of letter F), which is to be formed on the mask MA, is inverted in advance only in the scanning direction and reduced in size. During scanning exposure, a scanning direction SM1 of the mask MA and a scanning direction SP1 of the substrate PT are set in directions opposite to each other along the X-direction. As a result, a pattern with a desired shape is formed on the substrate PT. In this manner, when the magnified image of the first figure abdec and the second figure ABDEC have a line-symmetric (mirror reflection) relationship, the magnified image of the first figure abdec and the second figure ABDEC are also regarded as similar figures.

In the above embodiment, the projection optical systems PL1 to PL5 are set to have the same magnification. However, when the pattern is to be transferred in accordance with the non-linear distortion of the substrate PT that occurs when processing the substrate PT, for example, a first technique for performing scanning exposure in a state in which the projection optical systems-PL1 to PL5 have slightly different magnifications may be employed. Alternatively, a second technique for performing scanning exposure while slightly varying the magnifications may be employed.

In the first technique, the magnification is set independently for each of the plurality of projection optical systems PL1 to PL5 in accordance with the distortion amount of the substrate in the image fields of the projection optical systems PL1 to PL5. Then, scanning exposure is performed while shifting the image position in a substrate plane when necessary.

In the second technique, when performing scanning exposure with the first technique, the magnification of each of the projection optical systems PL1 to PL5 is changed in accordance with local distortion of the substrate PT in the scanning direction.

### Second Embodiment

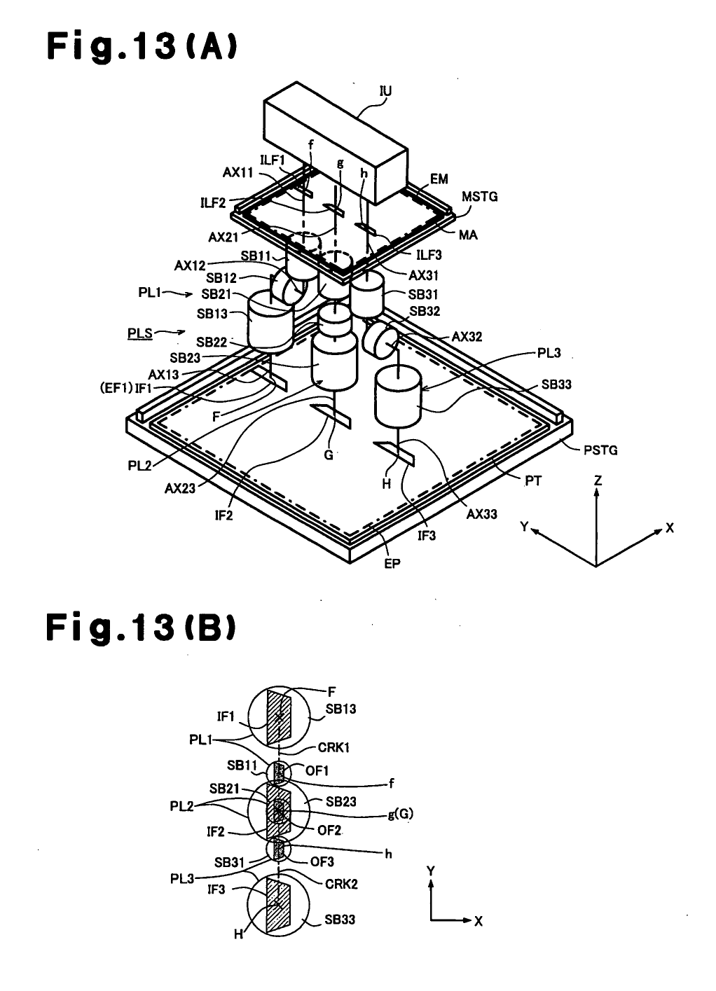

A second embodiment of the present invention will now be described with reference to FIGS. 13 to 17. A stage system of a scanning projection exposure apparatus according to the present embodiment is the same as the stage system described in the first embodiment. However, a projection optical apparatus PLS of the present embodiment differs from the projection optical apparatus PL of the first embodiment shown in FIG. 1 in that the projection optical apparatus PLS uses only single-row projection optical systems PL1 to PL3 instead of the first-row and second-row projection optical systems PL1 to PL5 and in that a light beam is shifted by a beam transmission member (beam deflection (folding) member) in a non-scanning direction, which is orthogonal to a scanning direction of a mask MA. The projection optical apparatus PL, which uses the single-row projection optical systems PL1 to PL3 in the second embodiment, performs scanning exposure twice to transfer the entire pattern of the mask MA onto the substrate PT. Hereafter, the components shown in FIGS. 13 to 17 corresponding to the components shown in FIGS. 1 to 4 will be given the same reference numerals as those components and may not be described in detail.

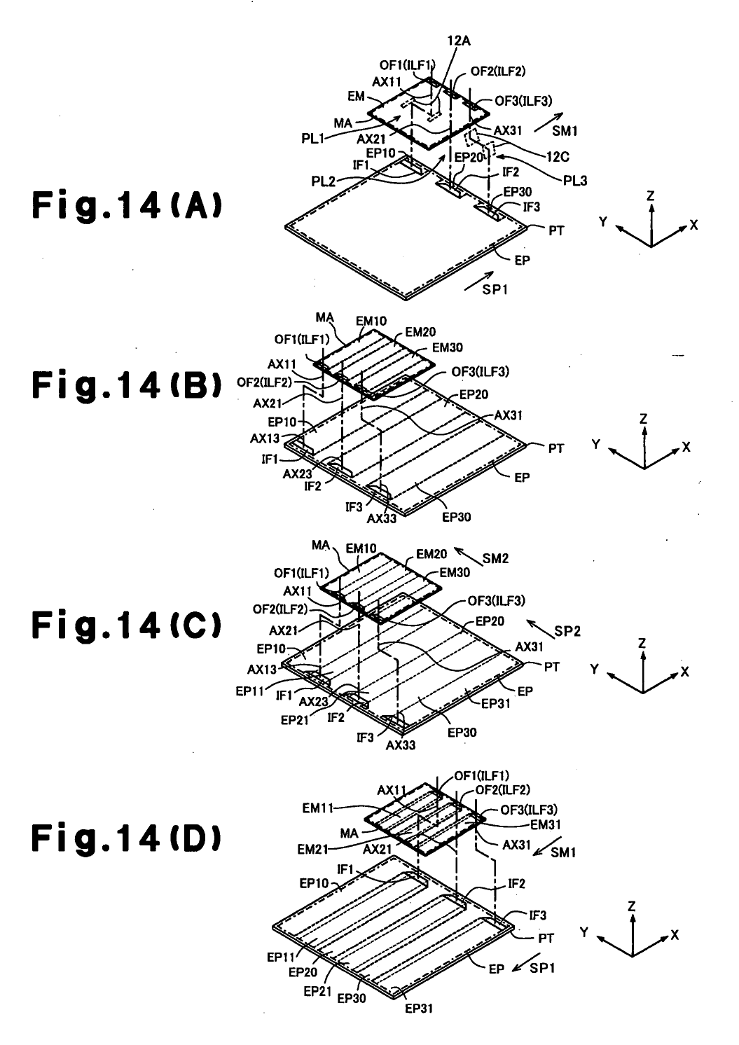

FIG. 13(A) is a schematic perspective view of the projection exposure apparatus of the present embodiment. FIG. 13(B) is a projection view showing the arrangement of the projection optical apparatus PLS included in the projection exposure apparatus. The projection optical apparatus PLS includes a plurality of projection optical systems. FIG. 14 schematically shows the operation of the projection exposure apparatus.

Referring now to FIGS. 13(A) and 13(B), the projection exposure apparatus of the present embodiment includes the projection optical apparatus PLS including the first to third projection optical systems PL1 to PL3. Here, the first to third projection optical systems PL11 and PL3 have substantially the same structure as the projection optical systems PL1 and PL2 shown in FIG. 5. The projection optical systems PL1 and PL3 differ from the projection optical systems PL1 and PL2 shown in FIG. 5 in that the beam deflection direction (shift direction) of the optical path deflection member (beam transmission member) of the projection optical systems PL1 and PL3 is the non-scanning direction (Y-direction) of the mask MA. The second projection optical system PL2 of the second embodiment does not include an optical deflection member (beam transmission member) and includes a plurality of partial optical systems SB21 to SB23 arranged on optical axes AX21 and AX23. The optical axes AX21 and AX23 extend on a straight line. With this structure, a center g of the view field OF2 of the second projection optical system PL2 and a center G of the image field IF2 (point conjugate to the center of the view field OF2) overlap each other when projected on the XY plane as shown in FIG. 13(B).

The projection-optical systems PL1 to PL3 of the second embodiment are arranged to form a predetermined row that extends in the non-scanning direction (Y-direction). The view fields OF1 to OF3 and the image fields IF1 to IF3 of the projection optical systems PL1 to PL3 are arranged at predetermined intervals in the scanning direction (X-direction) on a straight line that extends in the non-scanning direction (Y-direction). A figure fgh (first line segment), which is formed by linking the centers f, g, and h of the view fields OF1 to OF3, and a figure FGH, which is formed by linking points F, G, and H that are conjugate to the centers of the view fields OF1 to OF3 on the substrate PT (central points of the image fields IF1 to IF3), are similar figures. The ratio of similitude of these figures is equal to the enlargement magnification β of the projection optical systems PL1 to PL3. The center of similitude of these figures is on a straight line linking the central point g of the view field OF2 and the point G (central point of the image field IF2), which is conjugate to the central point g.

The distance between the central points f, g, and h of the view fields OF1 to OF3 is substantially equal to the width of each of the view fields OF1 to OF3 in the non-scanning direction (Y-direction). The distance between the central points F, G, and H of the view fields IF1 to IF3 is substantially equal to the width of each of the image fields IF1 to IF3 in the non-scanning direction (Y-direction). In FIG. 13(A), an illumination unit IU forms the illumination fields ILF1 to ILF3 on the mask MA in a manner that the illumination fields ILF1 to ILF3 have the same shape as the view fields OF1 to OF3 of the projection optical systems PL1 to PL3. However, the shape of the illumination fields ILF1 to ILF3 is not limited to the same shape as the view fields OF1 to OF3. The shape of the illumination fields ILF1 to ILF3 is only required to be such that the illumination fields ILF1 to ILF3 can be contained in the corresponding view fields OF1 to OF3 on a pattern surface (first surface) of the mask MA. The relationship between the shape of the illumination fields and the shape of the view fields is also satisfied in the first embodiment and its modifications.

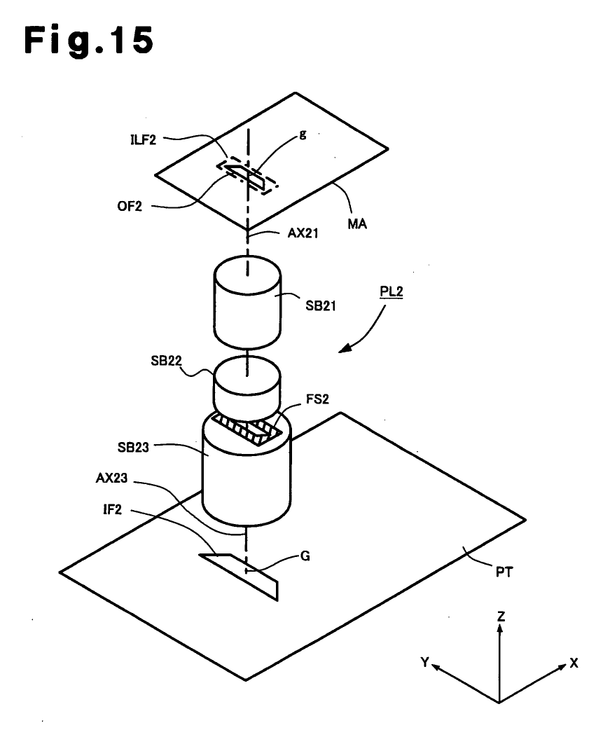

For example, the projection optical system PL2 may include a field stop FS2 as shown in FIG. 15. In this case, the illumination unit IU may form, for example, a rectangular illumination field ILF2 on the surface of the mask MA (first surface). The illumination unit IU may then shape a light beam from the mask MA using the field stop FS2, which has a polygonal aperture and is arranged in the vicinity of an intermediate image formation point of the projection optical system PL2. In this manner, the illumination unit IU may form an image field IF2 similar to the shape of the aperture portion of the field stop FS2 on the surface of the substrate PT (second surface).

Referring-back to FIG. 14, the exposure operation of the projection exposure apparatus according to the present embodiment will now be described. FIG. 14(A) shows a state immediately after the first scanning exposure is started. FIG. 14(B) shows a state immediately before the first scanning exposure is completed. FIG. 14(C) shows a state immediately before the second scanning exposure is started. FIG. 14(D) shows a state immediately after the second scanning exposure is completed. To simplify the drawings, FIGS. 14(A) to 14(D) do not show the first and third projection optical systems PL1 to PL3 and show only the optical axes of the projection optical systems PL1 to PL3 instead.

The image fields (projection fields) IF1 to IF3, which are arranged in a row in the non-scanning direction (Y-direction), are first aligned in a +Y-direction end portion of the pattern transfer field EP on the substrate PT. The view fields OF1 to OF3 are also aligned in a +Y-direction end portion of the pattern field EM on the mask MA. As shown in FIG. 14(A), the first scanning exposure is then performed while the mask MA and the substrate PT are moved in the +X-direction as indicated by arrows SM1 and SP1 at a velocity ratio that is in accordance with the magnification of the projection optical systems.

As shown in FIG. 14(B), the first scanning exposure, in which the image fields IF1 to IF3 for pattern image formation are moved in the −X-direction with respect to the substrate PT, causes a plurality of pattern transfer fields EP10 to EP30 to be formed on the substrate PT. The pattern transfer fields EP20 to EP30 are spaced in the non-scanning direction (Y-direction) and extend in the scanning direction (X-direction). After the first scanning exposure is completed, the mask MA and the substrate PT are moved in a stepwise manner in the non-scanning direction (−Y-direction) as indicated by arrows SM2 and SP2 by a movement amount of which ratio is in accordance with the magnification of the projection optical systems PL1 to PL3. Then, the second scanning exposure is started. As shown in FIG. 14(C), the second scanning exposure is performed while the mask MA and the substrate PT are moved in the −X-direction (direction opposite to the direction of the first scanning exposure) as indicated by the arrows SM1 and SP1 at a velocity ratio that is in accordance with the magnification of the projection optical systems PL1 to PL3.

As shown in FIG. 14(D), the second scanning exposure, in which the image fields IF1 to IF3 for pattern image formation are moved in the +X-direction with respect to the substrate PT, forms a plurality of pattern transfer fields EP11 to EP31 on the substrate PT. The pattern transfer fields EP11 to EP31 are spaced in the non-scanning direction (Y-direction) and extend in the scanning direction (X-direction).

The pattern transfer fields EP10 to EP30, which are formed through the first scanning exposure, and the pattern transfer fields EP11 to EP31, which are formed through the second scanning exposure, are overlapped in the non-scanning direction. The overlapped portions of the pattern transfer fields EP10 to EP30 and the pattern transfer fields EP11 to EP31 are fields that are exposed in an overlapped manner. In the first scanning exposure, the image field IF1 is in the shape of an inequilateral trapezoid and the image fields IF2 and IF3 are each in the shape of an isosceles trapezoid. In the second scanning exposure, the image fields IF1 and IF2 are each in the shape of an isosceles trapezoid and the image field IF3 is in the shape of an inequilateral trapezoid. Such exposure performed in alternate fields enables the pattern transfer fields to be larger with respect to the number of the projection optical systems PL1 to PL3.

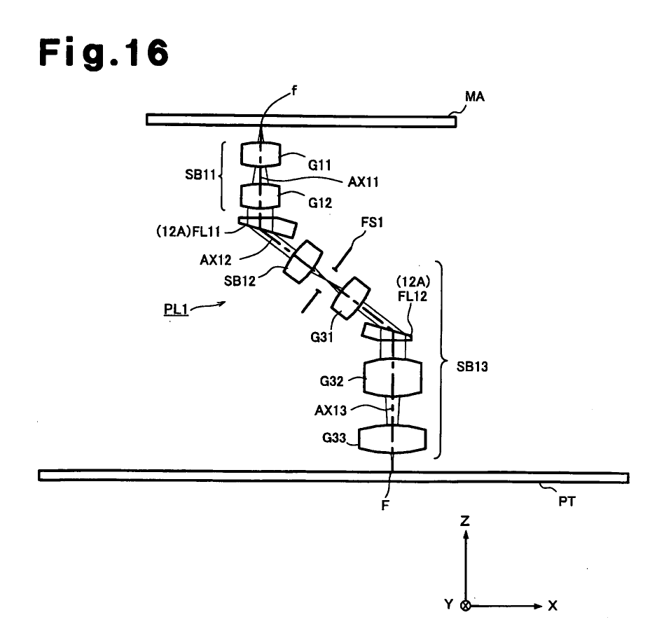

FIG. 16 shows another example of the projection optical system PL1 that can be used in the projection optical apparatuses PLS and PL shown in FIG. 13(A) and FIG. 1. In FIG. 6, the projection optical system PL1 uses a refractive member as a beam transmission member 12A (first and second deflection members) instead of a reflective member.

In FIG. 16, the first deflection member includes a first prism member FL11, and the second deflection member includes a second prism member FL12. The first prism member FL11 has a light entering surface that is aligned with a plane of which normal coincides with an optical axis AX11 of the first partial optical system SB11 and a light emitting surface aligned to form a wedge angle with respect to the light entering surface. A light beam entering the first prism member FL11 is deflected within the XZ plane and is emitted along an optical axis AX12 that tilts with respect to the optical axis AX11.

The second prism member FL12 has a light entering surface that faces the second partial optical system SB12 and is tilted with respect to the optical axis AX12 and a light emitting surface aligned with a plane of which normal coincides with an optical axis AX13 that is parallel to the optical axis AX11. A wedge angle formed by the light entering surface and the light emitting surface of the second prism member FL12 is equal to the wedge angle formed by the light entering surface and the light emitting surface of the first prism member FL11. A light beam entering the second prism member FL12 is deflected within the XZ plane, and is emitted along the optical axis AX13 that is parallel to the optical axis AX11.

In the example shown in FIG. 16, the first prism member FL11 and the second prism member FL12 form part of the beam transmission member. In FIG. 16, the light beam is transmitted in the scanning direction (X-direction). When the beam transmission member is rotated about Z-axis, the entering light beam may be transmitted to a position shifted in at least the non-scanning direction.

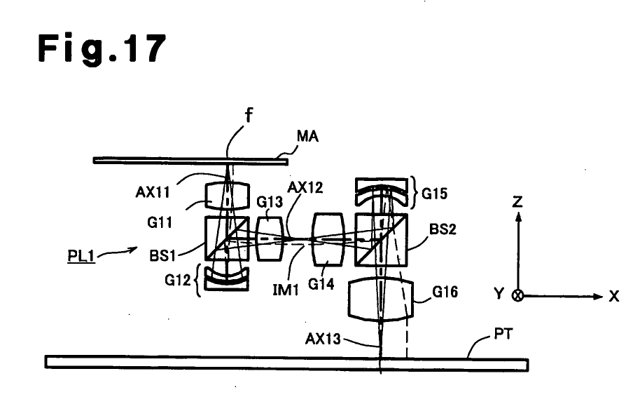

FIG. 17 shows a projection optical system PL1 according to another example. The projection optical system PL1 includes a catadioptric two-time imaging optical system that forms a single intermediate image instead of a refractive projection optical system. In FIG. 17, the projection optical system PL1 includes a first imaging optical system for forming an intermediate image IM1 and a second intermediate optical system for imaging the intermediate image IM1 again onto the substrate PT. The first imaging optical system includes a first group G11, which is arranged along an optical axis AX11 that extends in the direction of the normal to the surface of the mask MA, a beam splitter BS1, which is either an amplitude splitter or a polarization beam splitter, a second group G12, which includes a concave mirror CM1, and a third group G13, which is arranged along an optical axis AX12 that is orthogonal to the optical axis AX11 and extends parallel to the scanning direction (X-direction). The second imaging optical system includes a fourth group G14, which is arranged along the optical axis AX12, a beam splitter BS2, which is either an amplitude splitter or a polarization beam splitter, a fifth group G15, which includes a concave mirror CM1, and a sixth group G16, which is arranged along an optical axis AX13 that is parallel to the optical axis AX11 and extends parallel to the direction of the normal to the substrate PT.

In the example shown in FIG. 17, view fields and image fields are defined to include the optical axes AX11 and AX13 (on-axis view fields and on-axis image fields). Alternatively, the view fields and the image fields may be shifted from the optical axes AX11 and AX13. In other words, the view fields and the image fields may be off-axis view fields and off-axis image fields. In the example shown in FIG. 17, the splitting surface of the beam splitter BS1 corresponds to the first deflection member and the splitting surface of the beam splitter BS2 corresponds to the second deflection member. The direction in which the optical axis AX12 linking the beam splitters BS1 and BS2 extends corresponds to the first deflection direction.

In each of the above embodiments, the circuit pattern formed in the pattern fields of the mask MA is transferred to the single pattern transfer field on the substrate PT. Alternatively, the scanning exposure may be performed after the substrate PT is moved in the non-scanning direction and the exposure may be performed on a plurality of transfer fields on the substrate PT. In this case, the plurality of transfer fields may be separated from or overlapped with one another.

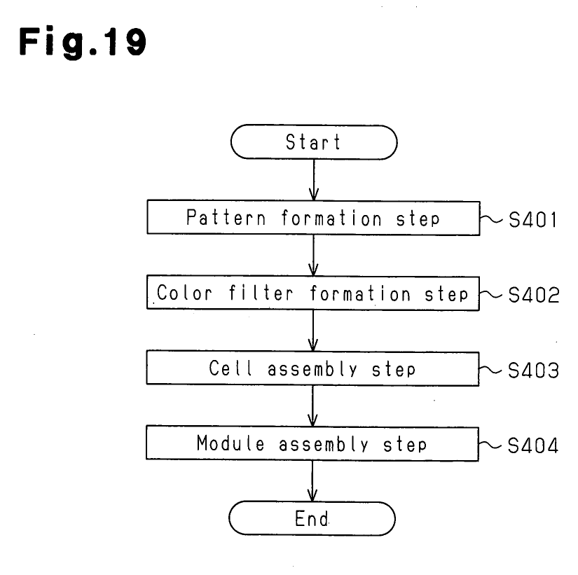

The scanning exposure apparatus using the projection optical system PL (or PLS) described above may be used to form a predetermined pattern (e.g., a circuit pattern or an electrode pattern) on a substrate (glass plate) to obtain a microdevice such as a liquid crystal display device. A method for manufacturing a liquid crystal display device using the scanning projection exposure apparatus will now be described with reference to the flowchart shown in FIG. 19.

In step S401 (pattern formation process) of FIG. 19, a coating process, an exposure process, and a developing process are performed. In the coating process, a photosensitive substrate is prepared by coating a substrate, on which exposure is to be performed, with photoresist. In the exposure process, a pattern of a mask for a liquid crystal display device is transferred and exposed on the photosensitive substrate using the scanning projection exposure apparatus. In the developing process, the photosensitive substrate is developed. The coating process, the exposure process, and the developing process constitute a lithography process, through which a predetermined resist pattern is formed on the substrate. After the lithography process, an etching process using the resist pattern as a mask, a resist removing process, and other processes are performed. Through these processes, a predetermined pattern including a large number of electrodes is formed on the substrate. The lithography and other processes are performed for a number of times in accordance with the number of layers formed on the substrate.

In step S402 (color filter formation process), a color filter is formed by arranging sets of three fine filters corresponding to red (R), green (G), and blue (B) in a matrix, or arranging sets of three striped R, G, and B filters in the horizontal scanning direction. In step S403 (cell assembly process), liquid crystal is injected between the substrate having a predetermined pattern, which is obtained for example through step S401, and the color filter, which is obtained for example through step S402. This completes a liquid crystal panel (liquid crystal cell).

In step S404 (module assembly process), other components including an electric circuit for enabling a display operation of the liquid crystal panel (liquid crystal cell) and a backlight are mounted on the completed liquid crystal panel (liquid crystal cell). This completes the manufacture of a liquid crystal display device. The manufacturing method for the liquid crystal display device described above uses the scanning projection exposure apparatus of the above embodiments that downsizes mask patterns. With this manufacturing method, a liquid crystal display device is manufactured at a low cost. In particular, the projection exposure apparatus using the projection optical system PL in FIG. 1 reduces errors in the continuity of images on the photosensitive substrate, and enables a device to be manufactured with a high precision.

The present invention should not be limited to the above embodiments but may be modified variously without departing from the scope and spirit of the present invention. Also, the components disclosed in the embodiments may be assembled in any combination for embodying the present invention. For example, some of the components may be omitted from all components disclosed in the embodiments. Further, components in different embodiments may be appropriately combined.

In the device manufacturing method according to the present invention, the projection optical apparatus according to the present invention is used to perform exposure in the exposure step. This reduces the size of a pattern on a first object (mask) and reduces continuity error of a projected image on a second object. Accordingly, microdevices and the like may be manufactured with high precision and a low manufacturing cost. Further, when using the second projection optical apparatus according to the present invention, patterns on a first object may all be transferred to a second object through a single scanning exposure. This improves the throughput.

What is claimed is:

1. A projection optical apparatus for forming a magnified image of a first object on a second object, wherein the first object and the second object are relatively moved in a predetermined scanning direction, the projection optical apparatus comprising:
first and second projection optical systems including an enlargement magnification, each of the first and second projection optical systems forming an image of part of the first object on the second object;
wherein when two arbitrary view points respectively corresponding to the first and second projection optical systems are defined on the first object, two conjugate points respectively corresponding to the two arbitrary points are defined on the second object, a first line segment is obtained by connecting the two view points, and a second line segment is obtained by connecting the two conjugate points, the first and second projection optical systems are arranged so that the first segment forms one side of a first figure, which is related with part of the first object, and the second line segment forms one side of a second figure, which is related with an image of part of the first object and which is a similar figure of the first figure of which magnification ratio relative to the first figure is the enlargement magnification; and
a light beam transmission member which transmits a light beam from an arbitrary view point corresponding to at least one of the first and second projection optical systems on the first object to the corresponding conjugate point on the second object by shifting the light beam from the view point in at least a direction orthogonal to the scanning direction.

2. The projection optical apparatus according to claim 1, wherein the light beam transmission member transmits a light beam from the arbitrary view point on the first object to the conjugate point on the second object by shifting the light beam from the view point in both of the scanning direction and the direction orthogonal to the scanning direction.

3. The projection optical apparatus according to claim 2, further comprising:
a plurality of projection optical systems including the first and second projection optical systems;
wherein when a plurality of arbitrary view points respectively corresponding to the plurality of projection optical systems are defined on the first object, a plurality of conjugate points respectively corresponding to the plurality of arbitrary points are defined on the second object, a first figure is obtained by connecting the plurality of view points, and a second line segment is obtained by connecting the plurality of conjugate points, the plurality of projection optical systems are arranged so that the second figure is a similar figure of the first figure of which magnification ratio relative to the first figure is the enlargement magnification; and
a plurality of view fields on the first object and a plurality of image fields on the second object respectively corresponding to the plurality of projection optical systems are arranged continuously in a direction intersecting the scanning direction.

4. The projection optical apparatus according to claim 3, wherein the second figure is an erected image or inverted image of the first figure.

5. The projection optical apparatus according to claim 4, wherein:
the first figure is the first line segment;
the second figure is the second line segment; and
a plurality of projection fields on the second object respectively corresponding to the plurality of projection optical systems are spaced form one another in a direction orthogonal to the scanning direction.

6. The projection optical apparatus according to claim 5, wherein the first and second projection optical systems form an erected image of part of the first object on the second object.

7. The projection optical apparatus according to claim 6, wherein at least one of the first and second projection optical systems forms an intermediate image of part of the first object and includes a view aperture arranged at the position at which the intermediate image is formed.

8. The projection optical apparatus according to claim 6, wherein at least one of the first and second projection optical systems includes:
first, second, and third partial optical systems arranged in order from a side closer to the first object to form an inverted image of part of the first object in entirety;
a first deflection member which deflects a light beam from the first partial optical system and which guides the light beam to the second partial optical system; and
a second deflection member which deflects a light beam from the second partial optical system and which guides the light beam to the third partial optical system;
wherein the first deflection member or the second deflection member includes a Dach surface for reflecting the light beam.

9. The projection optical apparatus according to claim 6, wherein at least one of the first and second projection optical systems forms an odd number of intermediate images of part of the first object.

10. The projection optical apparatus according to claim 6, wherein at least one of the first and second projection optical systems includes:
at least four deflection members, or first, second, third, and fourth deflection members, arranged in order from a side closer to the first object, wherein each deflection member deflects a light path of a light beam from the first object;
wherein the second and third deflection members each include a reflection surface including an optical axis, with the second and third deflection members being arranged so that a plane including normal vectors of the optical axes of the reflection surfaces is parallel to a pattern surface of the first object; and
light beam reflected by the second deflection member and entering the third deflection member is oriented in a direction that intersects the scanning direction.

11. The projection optical apparatus according to claim 1, wherein the first and second projection optical systems are image side telecentric optical systems in which a side closer to the second object is telecentric.

12. The projection optical apparatus according to claim 11, wherein the first and second projection optical systems are optical systems in which a side closer to an object is telecentric.

13. The projection optical apparatus according to claim 12, wherein two image fields formed on the second object by the first and second projection optical systems each includes a length in a longitudinal direction that extends along a direction orthogonal to the scanning direction.

14. A projection exposure apparatus for exposing a second object with illumination light via a first object, the projection exposure apparatus comprising:
an illumination optical system which illuminates the first object with the illumination light;
the projection optical apparatus according to claim 1 which forms an image of the first object illuminated by the illumination optical system on the second object; and
a stage mechanism which relatively moves the first object and the second object in the scanning direction using the magnification of the projection optical apparatus as a velocity ratio.

15. The projection exposure apparatus according to claim 19, wherein the stage mechanism moves the first object and the second object in the same direction when the second object is exposed.

16. The projection exposure apparatus according to claim 14, wherein the illumination optical system:
forms a plurality of illumination fields on the first object;
guides light via one of the plurality of illumination fields to the first projection optical system; and
guides light via another one of the illumination fields to the second projection optical system.

17. The projection exposure apparatus according to claim 16, wherein the illumination optical system includes a view aperture arranged at a position optically conjugate to the first object.

18. A projection optical apparatus for forming a magnified image of a first object on a second object, wherein the first object and the second object are relatively moved in a predetermined scanning direction, the projection exposure apparatus comprising:
first and second projection optical systems including an enlargement magnification, wherein each of the first and second projection optical systems forms an image of part of the first object on the second object;
wherein at least one of the first and second projection optical systems includes a light beam transmission member for transmitting a light beam from an arbitrary view point corresponding to the at least one of the first and second projection optical systems on the first object to a corresponding conjugate point on the second object by shifting the light beam from the view point in at least a direction orthogonal to the scanning direction.

19. The projection optical apparatus according to claim 18, wherein the light beam transmission member transmits a light beam from the arbitrary view point on the first object to the conjugate point on the second object by shifting the light beam from the view point in both of the scanning direction and the direction orthogonal to the scanning direction.

20. The projection optical apparatus according to claim 18, wherein the magnification of the first projection optical system differs from the magnification of the second projection optical system.

21. The projection optical apparatus according to claim 18, wherein the first and second projection optical systems are image side telecentric optical systems in which a side closer to the second object is telecentric.

22. The projection optical apparatus according to claim 21, wherein the first and second projection optical systems are optical systems in which a side closer to an object is telecentric.

23. The projection optical apparatus according to claim 18, wherein two image fields formed on the second object by the first and second projection optical systems each have a length in a longitudinal direction that extends along a direction orthogonal to the scanning direction.

24. A projection exposure apparatus for exposing a second object with illumination light via a first object, the projection exposure apparatus comprising:
an illumination optical system which illuminates the first object with the illumination light;
the projection optical apparatus according to claim 18 which forms an image of the first object illuminated by the illumination optical system on the second object; and
a stage mechanism which relatively moves the first object and the second object in the scanning direction using the magnification of the projection optical apparatus as a velocity ratio.

25. The projection exposure apparatus according to claim 24, wherein the stage mechanism moves the first object and the second object in the same direction when the second object is exposed.

26. The projection exposure apparatus according to claim 25, wherein the illumination optical system:
forms a plurality of illumination fields on the first object;
guides light via one of the plurality of illumination fields to the first projection optical system; and
guides light via another one of the illumination fields to the second projection optical system.

27. The projection exposure apparatus according to claim 26, wherein the illumination optical system includes a view aperture arranged at a position optically conjugate to the first object.

28. A projection exposure apparatus for forming a magnified image of a first object on a second object while relatively moving the first object and the second object in a predetermined scanning direction, the projection exposure apparatus comprising:
a plurality of projection optical systems including an enlargement magnification, wherein each of the projection optical systems forms an image of part of the first object on the second object; and
an illumination optical system which forms a plurality of illumination fields on the first object;
wherein the plurality of illumination fields are arranged in a direction orthogonal to the scanning direction, with adjacent ones of the illumination fields partially overlapping each other.

29. The projection exposure apparatus according to claim 28, wherein the plurality of illumination fields each have a length in a longitudinal direction that extends along a direction orthogonal to the scanning direction.

30. The projection exposure apparatus according to claim 29, wherein the magnification of the first projection optical system differs from the magnification of the second projection optical system.

31. An exposure method for exposing a second object with illumination light via a first object, the exposure method comprising:
illuminating the first object with the illumination light;
projecting an image of the illuminated first object onto the second object with the projection optical apparatus according to claim 1; and
relatively moving the first object and the second object in the scanning direction using the magnification of the projection optical apparatus as a velocity ratio.

32. An exposure method for exposing a second object with illumination light via a first object, the exposure method comprising:
forming a plurality of illumination fields, which includes a first illumination field and a second illumination field differing from the first illumination field, on the first object with the illumination light;
forming a magnified image of the first object in accordance with a predetermined magnification in each of a plurality of exposure fields on the second object with light from the plurality of illumination fields; and
moving the first object and the second object relative to each other using the predetermined magnification as a velocity ratio;
wherein a field swept on the first object by the first illumination field in said moving and a field swept on the first object by the second illumination field in said moving are partially overlapped with each other.

33. The exposure method according to claim 32, wherein the plurality of illumination fields each have a length in a longitudinal direction that extends along a direction orthogonal to the scanning direction.

34. The exposure method according to claim 33, wherein the magnified image of the first object is formed in the plurality of exposure fields with different magnifications.

35. The exposure method according to claim 34, wherein the magnification of the magnified image of the first object formed in the plurality of exposure fields is varied in said moving.

36. An exposure method for exposing a second object with illumination light via a first object, the exposure method comprising:
illuminating the first object with the illumination light;
projecting an image of the illuminated first object onto the second object with the projection optical apparatus according to claim 11; and
relatively moving the first object and the second object in the scanning direction using the magnification of the projection optical apparatus as a velocity ratio.

37. A device manufacturing method comprising:
exposing a pattern of a mask on a photosensitive substrate using the projection exposure apparatus according to claim 14;
developing the photosensitive substrate exposed in said exposing and generating a mask layer shaped in correspondence with the pattern on a surface of the photosensitive substrate; and
processing the surface of the photosensitive substrate via the mask.

38. A device manufacturing method comprising:
exposing a pattern of a mask on a photosensitive substrate using the projection exposure apparatus according to claim 24;
developing the photosensitive substrate exposed in said exposing and generating a mask layer shaped in correspondence with the pattern on a surface of the photosensitive substrate; and
processing the surface of the photosensitive substrate via the mask.

39. A device manufacturing method comprising:
exposing a pattern of a mask on a photosensitive substrate using the projection exposure apparatus according to claim 28;
developing the photosensitive substrate exposed in said exposing and generating a mask layer shaped in correspondence with the pattern on a surface of the photosensitive substrate; and
processing the surface of the photosensitive substrate via the mask.
